(19) United States
(12) Patent Application Publication
(10) Pub. No.: US 2023/0324179 A1
(43) Pub. Date: Oct. 12, 2023

(54) INERTIAL MEASUREMENT DEVICE

(71) Applicant: SEIKO EPSON CORPORATION, Tokyo (JP)

(72) Inventors: Yoshikuni Saito, Kofu-shi (JP); Taketo Chino, Hokuto-shi (JP); Yoshiyuki Matsuura, Shiojiri-shi (JP)

(21) Appl. No.: 18/296,428

(22) Filed: Apr. 6, 2023

(30) Foreign Application Priority Data
Apr. 8, 2022 (JP) 2022-064373

(51) Int. Cl. G01C 21/16

(52) U.S. Cl. CPC G01C 21/16

(57) ABSTRACT

An inertial measurement device includes: a first inertial sensor having at least a first detection axis; and a second inertial sensor having at least a second detection axis and paired with the first inertial sensor. The first inertial sensor and the second inertial sensor are mounted on a circuit board in a state where a direction of the first detection axis of the first inertial sensor is rotated by 180° with respect to a direction of the second detection axis of the second inertial sensor. The inertial measurement device further includes a case accommodating the circuit board. Spaces between the first inertial sensor and the case and between the second inertial sensor and the case are filled with resin.

The present application is based on, and claims priority from JP Application Serial Number 2022-064373, filed Apr. 8, 2022, the disclosure of which is hereby incorporated by reference herein in its entirety.

### BACKGROUND

### 1. Technical Field

The present disclosure relates to an inertial measurement device.

### 2. Related Art

An inertial measurement device including a plurality of inertial sensors such as acceleration sensors or angular velocity sensors is known. For example, JP-A-2019-168381 discloses a sensor unit including a six-axis motion sensor including a three-axis acceleration sensor and a three-axis angular velocity sensor. According to JP-A-2019-168381, the acceleration sensor is a capacitive acceleration sensor obtained by processing a silicon substrate by MEMS technology, and is mounted on a circuit board together with the angular velocity sensor and accommodated in a metal case. The acceleration sensor is a surface-mounted component, and is surface-mounted on an electrode pad provided on the circuit board by soldering. As such a surface-mounted component, for example, a component formed of a resin package molded with resin is known.

According to JP-A-2019-168381, by not providing a resist between the circuit board and the acceleration sensor, cleanability between the circuit board and the acceleration sensor after mounting the acceleration sensor is enhanced, and foreign matters such as flux is prevented from remaining under the acceleration sensor. This prevents deterioration of detection accuracy due to the residual foreign matters.

However, there is room for improvement in the sensor unit in JP-A-2019-168381. Specifically, there is a problem in that the detection accuracy deteriorates due to the influence of temperature and humidity. The resin package is likely to be affected by humidity, and the detection accuracy may be deteriorated. In addition, due to inclusion of materials having different linear expansion coefficients, an output value of the acceleration sensor has different temperature hysteresis characteristics between when the temperature rises and when the temperature falls at the same temperature point, which causes deterioration of the detection accuracy. Further, warp of the circuit board due to an influence of a temperature change or the like also becomes a factor of the deterioration of the detection accuracy.

That is, there has been a demand for an inertial measurement device having excellent temperature characteristics and moisture resistance characteristics and high detection accuracy.

### SUMMARY

An inertial measurement device according to one aspect of the present application includes: a first inertial sensor having at least a first detection axis; and a second inertial sensor having at least a second detection axis and paired with the first inertial sensor. The first inertial sensor and the second inertial sensor are mounted on a circuit board in a state where a direction of the first detection axis of the first inertial sensor is rotated by 180° with respect to a direction of the second detection axis of the second inertial sensor. The inertial measurement device further includes a case accommodating the circuit board. Spaces between the first inertial sensor and the case and between the second inertial sensor and the case are filled with resin.

### BRIEF DESCRIPTION OF THE DRAWINGS

FIG. 1 is a perspective view showing a fixing status of an inertial measurement device according to a first embodiment to a mounted surface.

FIG. 2 is a perspective view of the inertial measurement device as viewed from a mounted surface side.

FIG. 3 is an exploded perspective view of the inertial measurement device.

FIG. 4 is a perspective view of a circuit board.

FIG. 5 is a plan view of the circuit board.

FIG. 6 is a graph showing an example of a temperature hysteresis characteristic of an acceleration sensor.

FIG. 7 is a graph showing an example of the temperature hysteresis characteristic of the acceleration sensor.

FIG. 8 is a graph showing an example of the temperature hysteresis characteristic of the acceleration sensor.

FIG. 9 is a graph showing an example of the temperature hysteresis characteristic of the acceleration sensor.

FIG. 10 is a perspective cross-sectional view taken along a line f-f of FIG. 2.

FIG. 11 is a cross-sectional view taken along the line f-f of FIG. 2.

FIG. 12 is a cross-sectional view taken along a line j-j in FIG. 10.

FIG. 13 is a list of Examples and Comparative Examples.

FIG. 14 is a plan view of a circuit board according to a second embodiment.

FIG. 15 is a cross-sectional view taken along the line f-f of FIG. 2.

FIG. 16 is a plan view of a circuit board according to a third embodiment.

FIG. 17 is a cross-sectional view taken along the line j-j in FIG. 10.

FIG. 18 is a plan view of a circuit board according to a fourth embodiment.

FIG. 19 is a plan view of a circuit board according to a fifth embodiment.

FIG. 20 is a cross-sectional view taken along a line k-k in FIG. 19.

### DESCRIPTION OF EXEMPLARY EMBODIMENTS

### First Embodiment

### Outline of Inertial Measurement Device

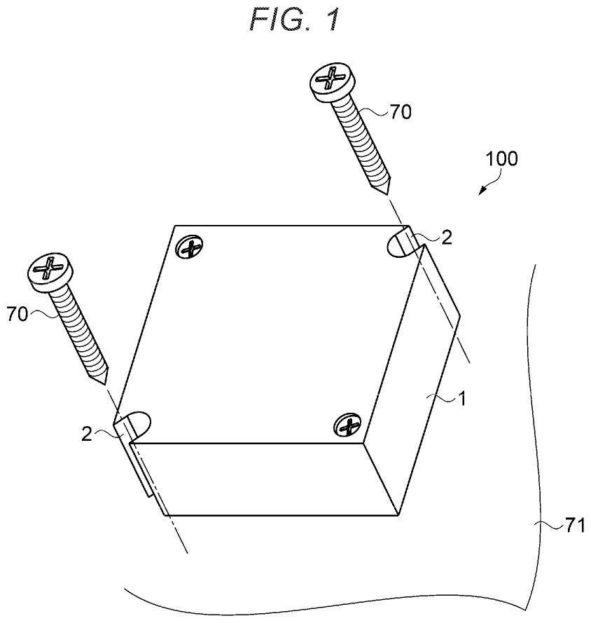

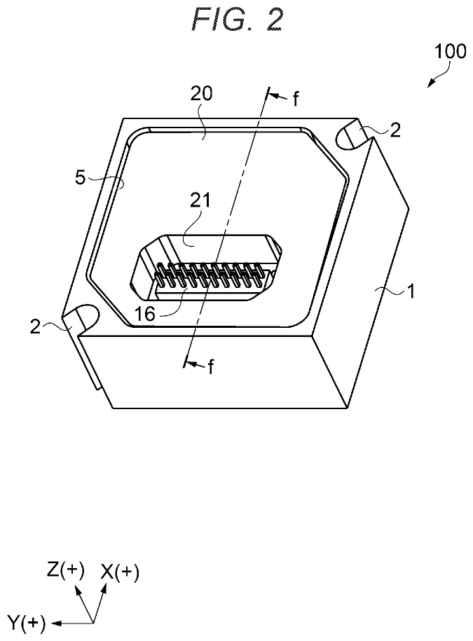

FIG. 1 is a perspective view showing a fixing status of an inertial measurement device according to a first embodiment to a mounted surface. FIG. 2 is a perspective view of the inertial measurement device as viewed from a mounted surface side.

First, an outline of an inertial measurement device 100 according to the embodiment will be described.

The inertial measurement device 100 shown in FIG. 1 is an inertial measurement unit (IMU) that detects a posture or a behavior of amounted body such as an automobile or a robot. The inertial measurement device 100 functions as a six-axis motion sensor including a three-axis acceleration sensor and a three-axis angular velocity sensor.

The inertial measurement device 100 has a rectangular parallelepiped shape in which a planar shape is substantially square, and is formed to be compact such that a length of one side of the square is about several centimeters. Notch holes 2 are provided at two places in a diagonal direction of the inertial measurement device 100. The inertial measurement device 100 is fixed to a mounted surface 71 of a mounted body such as an automobile by two screws 70 inserted into the notch holes 2. The mounted body is not limited to a moving body such as an automobile, and may be, for example, a construction such as a bridge or an elevated track. When the inertial measurement device 100 is attached to a construction, the inertial measurement device 100 is used as a structural health monitoring system that checks health of the construction.

### Basic Configuration of Inertial Measurement Device

As shown in FIG. 2, the inertial measurement device 100 has a configuration in which an inner case 20 is accommodated in a rectangular parallelepiped outer case 1. A rectangular opening 21 is formed in the inner case 20. Hereinafter, a long-side direction of the opening 21 is referred to as a Y(+) direction. In addition, a direction orthogonal to the Y(+) direction is referred to as an X(+) direction, and a thickness direction of the outer case 1 is referred to as a Z(+) direction, and the directions are indicated by coordinate axis. A plug connector 16 is exposed from the opening 21 of the inner case 20, and the Y(+) direction coincides with an arrangement direction of a plurality of pins in the connector 16.

In addition, the coordinate axis is a detection axis by an inertial measurement sensor of the inertial measurement device 100, and is hereinafter also referred to as an IMU detection axis.

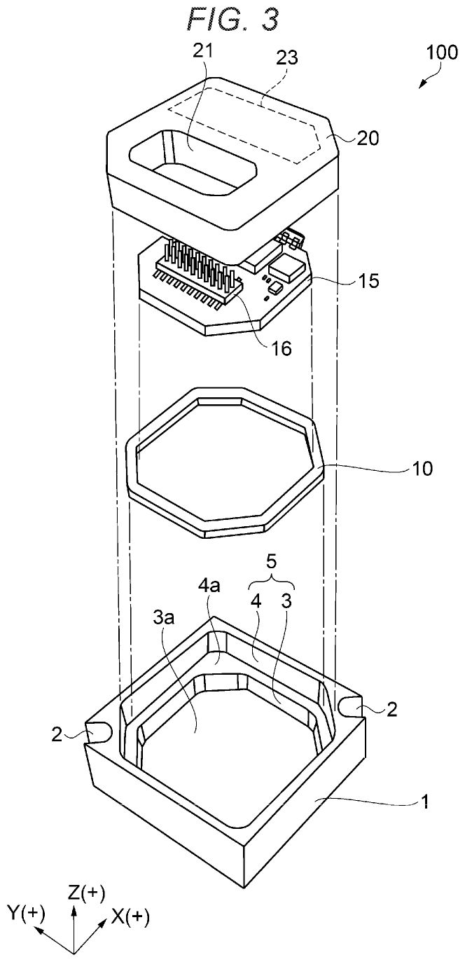

FIG. 3 is an exploded perspective view of the inertial measurement device.

As shown in FIG. 3, the inertial measurement device 100 includes the outer case 1, a joint member 10, a circuit board 15, the inner case 20, and the like. The inner case 20 corresponds to a first case, and the outer case 1 corresponds to a second case.

The outer case 1 is a box-shaped housing having a rectangular parallelepiped outer shape. In a preferred example, aluminum is employed as a material. The material is not limited to aluminum, and other metals or ceramics may be used, but details of options for the material will be described later. The two notch holes 2 described above are formed on an outer side of the outer case 1. The configuration is not limited notch hole 2, and for example, a round hole (through hole) may be formed for screwing, or a flange (ear) may be formed on a side surface of the outer case 1 and a flange portion may be screwed.

The outer case 1 is provided with an accommodation portion 5 for accommodating the inner case 20 in a state where the circuit board 15 is set.

The accommodation portion 5 includes a first concave portion 3 having a bottom portion 3a as a bottom surface, and a second concave portion 4 having a receiving portion 4a surrounding the first concave portion 3. The circuit board 15 is accommodated in the first concave portion 3. The receiving portion 4a is a ring-shaped receiving portion of the inner case 20 rising in a stepped manner from the bottom portion 3a, and the inner case 20 is accommodated in the second concave portion 4 via the joint member 10.

The joint member 10 is a buffer member made of resin and disposed between the outer case 1 and the inner case 20. The joint member 10 is a ring-shaped member similar to the receiving portion 4a, and is set on the receiving portion 4a.

The inner case 20 is a member that supports the circuit board 15, and is formed in a shape that can be accommodated in the second concave portion 4 of the outer case 1. The inner case 20 is made of the same material as that of the outer case 1, and is made of aluminum in a preferred example. The inner case 20 is provided with the opening 21 for exposing the connector 16 of the circuit board 15 to the outside, and a third concave portion 23 for accommodating electronic components mounted on the circuit board 15. The third concave portion 23 is actually filled with resin, and illustration thereof is omitted in FIG. 3. In addition, the first concave portion 3 of the accommodation portion 5 in the outer case 1 can also be filled with resin in the same manner, but illustration thereof is omitted in FIG. 3.

Refer Back to FIG. 1.

With such a configuration, in a state where the inner case 20 including the circuit board 15 is accommodated in the outer case 1 and integrated with the outer case 1, the inertial measurement device 100 is fixed to the mounted surface 71 of the mounted body by the two screws 70 and to be used.

### Configuration of Circuit Board

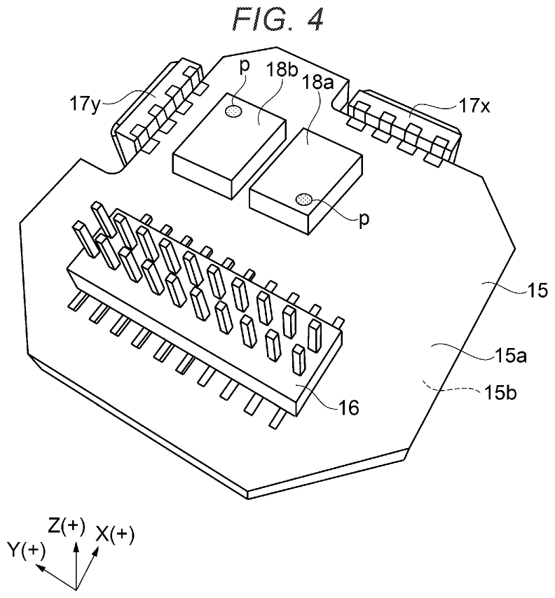

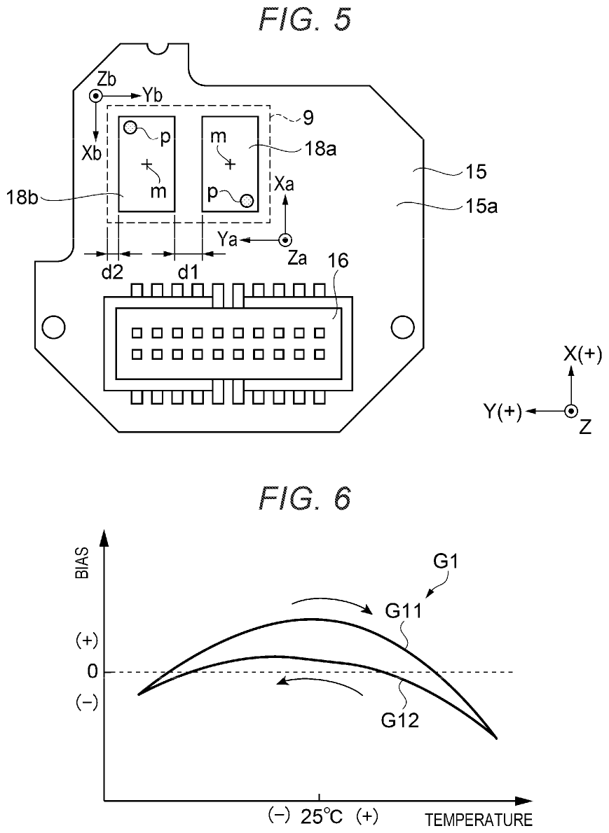

FIG. 4 is a perspective view of a circuit board. FIG. 5 is a plan view of the circuit board.

In a preferred example, a multilayer glass epoxy board is used as the circuit board 15. An outer shape of the circuit board 15 is formed in a deformed octagonal shape in which a part thereof is cut in a plan view.

A surface of the circuit board 15 on a Z(+) side is referred to as a first surface 15a, and a surface opposite from the first surface 15a is referred to as a second surface 15b. The first surface 15a is also referred to as a front surface and the second surface 15b is also referred to as a back surface. In addition, electronic components can also be mounted on a side surface of the circuit board 15.

As shown in FIG. 4, the connector 16 extends along one side of the circuit board 15. The connector 16 is a plug connector, and includes two rows of connection terminals arranged at equal pitches along the Y(+) direction. A shroud-type connector having a wall surrounding the connection terminals may be used.

An angular velocity sensor 17x is mounted on a side surface of the circuit board 15 on one side in the X(+) direction. The angular velocity sensor 17x is a gyro sensor that detects an angular velocity around an X axis. As a preferred example, a vibration gyro sensor is used in which quartz crystal is used as a vibrator and an angular velocity is detected from Coriolis force applied to a vibrating object. The sensor is not limited to the vibration gyro sensor, and may be a sensor capable of detecting an angular velocity. For example, a sensor using ceramic or silicon as the vibrator may be used.

An angular velocity sensor 17y is mounted on a side surface of the circuit board 15 on one side in the Y(+) direction. The angular velocity sensor 17y is a gyro sensor that detects an angular velocity around a Y axis. Although not shown in FIG. 4, an angular velocity sensor 17z that detects an angular velocity around a Z axis is mounted on the first surface 15a. The angular velocity sensor 17y and the angular velocity sensor 17z use the same gyro sensor as the angular velocity sensor 17x, and correspond to an inertial sensor.

### Mounting Status of Acceleration Sensor

As shown in FIG. 5, an acceleration sensor 18a as a first inertial sensor and an acceleration sensor 18b as a second inertial sensor are disposed side by side in the X(+) direction of the connector 16.

As the acceleration sensor 18a, a capacitance type acceleration sensor that can detect accelerations in three directions (three axes) of the X axis, the Y axis, and the Z axis by one device and is obtained by processing a silicon substrate by MEMS technology is used. The acceleration sensor 18a is a surface-mounted component including a resin package molded with resin, and is surface-mounted on an electrode pad (not shown) provided on the first surface 15a of the circuit board 15 by soldering.

The acceleration sensor 18a has a rectangular outer shape, and is disposed such that a long-side direction thereof is along the X(+) direction, and a center point m is substantially a center of the rectangle. A reference point p, which is a symbol for identifying a direction of a detection axis, is attached to one vertex of the rectangle. Note that the center point m and the reference point p are provided for convenience of description, and may not be provided in an actual device.

In the acceleration sensor 18a, since the reference point p is located at the vertex in a X(−) direction and a Y(−) direction, detection directions are an Xa direction, a Ya direction, and a Za direction as indicated by a coordinate axis. The Xa direction is the same as the X(+) direction of the IMU detection axis, the Ya direction is the same as the Y(+) direction of the IMU detection axis, and the Za direction is the same as the Z(+) direction of the IMU detection axis. The Xa direction, the Ya direction, and the Za direction correspond to a first detection axis of the acceleration sensor 18a.

That is, directions of the detection axis of the acceleration sensor 18a as the first inertial sensor coincide with those of the IMU detection axis.

The acceleration sensor 18b is the same acceleration sensor as the acceleration sensor 18a, but a mounting direction is different. Specifically, the acceleration sensor 18b is mounted in a state of being rotated by 180° from the acceleration sensor 18a with the center point m as a rotation center on the first surface 15a. Therefore, the reference point p of the acceleration sensor 18b and the reference point p of the acceleration sensor 18a are at positions rotated by 180°.

In the acceleration sensor 18b, since the reference point p is located at the vertex in the X(+) direction and the Y(+) direction, detection directions are an Xb direction, a Yb direction, and a Zb direction as indicated by a coordinate axis. The Xb direction is opposite from the X(+) direction of the IMU detection axis. The Yb direction is opposite from the Y(+) direction of the IMU detection axis. The Zb direction is the same as the Z(+) direction of the IMU detection axis. The Xb direction, the Yb direction, and the Zb direction correspond to a second detection axis of the acceleration sensor 18b. That is, detection directions of the acceleration sensor 18b on the X axis and the Y axis are reversed with respect to the detection directions of the acceleration sensor 18a.

In other words, the acceleration sensor 18a and the acceleration sensor 18b are mounted on the circuit board 15 in a state where the Xa direction as the direction of the first detection axis of the acceleration sensor 18a and the Xb direction as the direction of the second detection axis of the acceleration sensor 18b are rotated by 180°. The same applies to the Ya direction and the Yb direction. Note that the present disclosure is not limited to the X axis and the Y axis, and may be implemented in any mounting status as long as the sensor includes a detection axis in which the direction of the first detection axis of the acceleration sensor 18a and the direction of the second detection axis of the acceleration sensor 18b are opposite from each other.

The acceleration sensor 18a and the acceleration sensor 18b are adjacent to each other in the Y(+) direction, and are disposed with a gap d1 therebetween. The gap d1 is obtained by Formula (1), where h is a package height of the acceleration sensor 18a.

d1≥h/1.66 Formula (1)

Formula (1) is derived from experimental results by inventors or the like, and when the gap d1 is secured, it is possible to reliably fill a space between the acceleration sensor 18a and the acceleration sensor 18b with resin described later.

In FIG. 5, a rectangular dotted line surrounding the acceleration sensor 18a and the acceleration sensor 18b indicates a resist 9. No resist 9 is provided immediately below and around the acceleration sensors 18a and 18b. A gap d2 is provided between the acceleration sensor 18b and the resist 9. The same applies between the acceleration sensor 18a and the resist 9. In the preferred example, the gap d2 is 0.15 mm or more. As described above, the resist 9 is not provided immediately below the acceleration sensors 18a and 18b, and the gap d2 around the acceleration sensors 18a and 18b is secured, thereby improving cleaning performance after mounting and preventing foreign matters such as flux from remaining.

Refer Back to FIG. 4.

A control IC (not shown) is mounted on the second surface 15b of the circuit board 15. The control IC is a micro controller unit (MCU), includes a storage unit including a nonvolatile memory, an A/D converter, and the like, and integrally controls each unit of the inertial measurement device 100. The storage unit stores a program defining an order and contents for detecting the acceleration and the angular velocity, a program for digitizing detection data and incorporating the digitized detection data into packet data, accompanying data, and the like.

In addition, a plurality of electronic components other than those described above are mounted on the circuit board 15, but illustration thereof is omitted.

### Method for Correcting Temperature Hysteresis Characteristic

FIGS. 6 to 9 are graphs showing examples of the temperature hysteresis characteristic of the acceleration sensor.

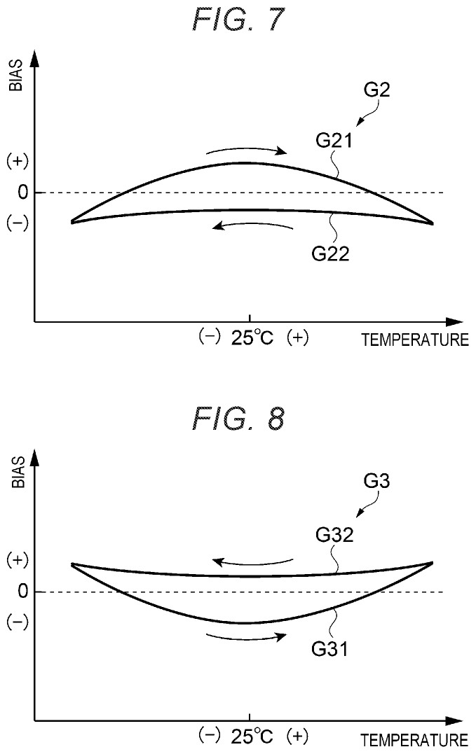

FIG. 6 is a graph showing the temperature hysteresis characteristic of the acceleration sensor 18a, in which a horizontal axis represents a temperature and a vertical axis represents a bias of a sensor output. Physical quantities and units of the horizontal axis and the vertical axis are the same in FIGS. 7 to 9.

As described with reference to FIG. 5, the inertial measurement device 100 includes a pair of the acceleration sensor 18a and the acceleration sensor 18b that are disposed in a state in which the directions of the detection axes of the acceleration sensor 18a and the acceleration sensor 18b are rotated by 180°. This is because the temperature hysteresis characteristic of the acceleration sensor 18a having the detection axis coinciding with the IMU detection axis is corrected using a detection value of the acceleration sensor 18b having the opposite detection axis. Hereinafter, temperature characteristics of the sensor output on the X axis will be described as an example.

First, a graph G1 of FIG. 6 shows a temperature characteristic of a sensor output of the acceleration sensor 18a as the first inertial sensor. Specifically, in the graph G1, when the temperature rises, as shown in a graph G11, a convex characteristic is obtained in which a negative bias is applied in a low temperature range, a positive bias is applied as the temperature rises, a highest bias is applied in the vicinity of 25°, and the negative bias is applied in a high temperature range. Then, as shown in the graph G12, when the temperature decreases, a convex characteristic is obtained in which a negative bias is applied in a high temperature range, a positive bias is applied as the temperature decreases, a highest bias is applied in the vicinity of 25°, and the negative bias is applied in a low temperature range. Here, it can be seen that the graph G11 and the graph G12 are separated from each other in the vicinity of 25°, and a temperature hysteresis occurs.

Next, a graph G2 of FIG. 7 shows a temperature characteristic of a sensor output of the acceleration sensor 18b as the second inertial sensor. Similarly to the graph G1, the graph G2 is a convex graph G21 when the temperature rises, and is a convex graph G22 when the temperature decreases. In addition, similarly to the graph G1, the temperature hysteresis occurs between the graph G21 and the graph G22.

A graph G3 of FIG. 8 is a graph obtained by reversing the sensor output of the graph G2. Specifically, a sign of a sensor output value of the acceleration sensor 18b is reversed by the control IC (not shown) of the circuit board 15. The graph G3 is a concave graph G31 when the temperature rises, and is a concave graph G32 when the temperature decreases, and is a graph obtained by vertically reversing the graph G2.

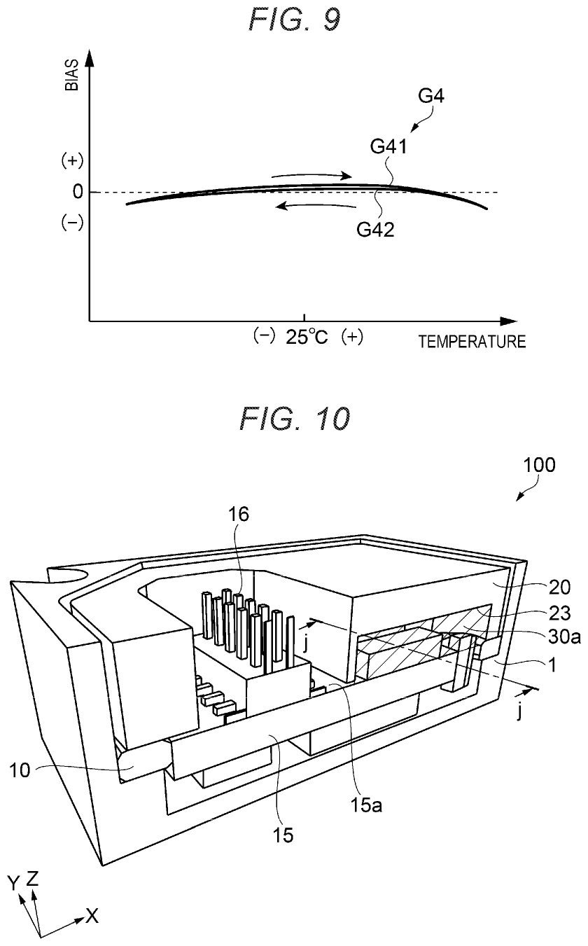

A graph G4 of FIG. 9 is a graph obtained by combining and averaging the graphs G1 and G3. Specifically, a sensor output obtained by adding the reversed sensor output of the acceleration sensor 18b to the sensor output of the acceleration sensor 18a and dividing the sensor outputs by 2 is shown.

As shown in FIG. 9, the graph G4 is a gentle convex graph G41 when the temperature rises, and a gentle convex graph G42 when the temperature decreases, resulting in substantially flat characteristics as a whole. It can be seen that the graph G41 and the graph G42 substantially overlap each other, and almost no temperature hysteresis occurs between the graph G41 and the graph G42.

In this manner, the temperature hysteresis characteristic can be cancelled (offset) by using an average value of the sensor output of the acceleration sensor 18a and the reversed sensor output of the acceleration sensor 18b as an output of the acceleration sensor in the inertial measurement device 100.

Although the method for correcting the temperature hysteresis characteristic on the X axis is described above, the temperature hysteresis characteristics on the Y axis and the Z axis can be corrected by the same method.

In the above description, the acceleration sensor is described as an example of the inertial sensor, but the present disclosure is not limited thereto, any sensor capable of detecting an inertial force may be used, and for example, the present disclosure may be applied to an angular velocity sensor.

### Improvement in Moisture Resistance and Warp Countermeasure of Circuit Board

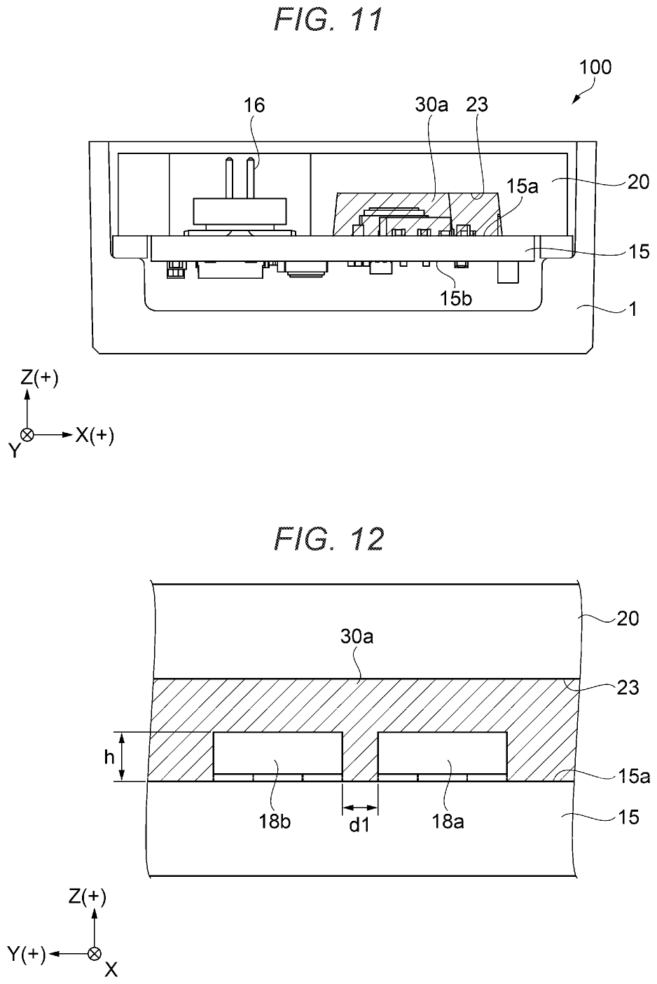

FIG. 10 is a perspective cross-sectional view taken along a line f-f of FIG. 2. FIG. 11 is a cross-sectional view taken along the line f-f of FIG. 2. FIG. 12 is a cross-sectional view taken along a line j-j in FIG. 10.

Here, improvement in moisture resistance and a warp countermeasure of the circuit board will be described.

As shown in FIGS. 10 and 11, in this mounting status, spaces between the acceleration sensor 18a and the inner case 20 and between the acceleration sensor 18b and the inner case 20 are filled with resin 30a. Specifically, a space between the third concave portion 23 of the inner case 20 and the first surface 15a of the circuit board 15 is filled with the resin 30a. The resin 30a covers the electronic components including the acceleration sensors 18a and 18b mounted on the first surface 15a, and an inside of the third concave portion 23 is filled with the resin 30a. At this time, as shown in FIG. 12, the gap d1 between the acceleration sensor 18a and the acceleration sensor 18b is also filled with the resin 30a. In other words, if a distance equal to or larger than the gap d1 is secured between the acceleration sensor 18a and the acceleration sensor 18b, the gap can be reliably filled with the resin 30a. It should be noted that the gap d1 is set to a dimension that satisfies the above-described Formula (1) when the package height of the acceleration sensors 18a and 18b is h.

A purpose of filling with the resin 30a is to prevent intrusion of humidity by sealing the acceleration sensors 18a and 18b with the resin 30a, and to prevent warp of the circuit board 15 by joining the circuit board 15 and the inner case 20 with the resin 30a and integrating the circuit board 15 with the inner case 20 made of metal with less temperature deformation. Therefore, the resin 30a is preferably resin having a high hardness after curing.

In a preferred example, a one-liquid thermosetting epoxy adhesive is used as the resin 30a. The epoxy adhesive preferably has a hardness of 80D or more after curing in terms of a type D durometer in a durometer hardness test of JIS7215-1986.

When a linear expansion coefficient of the circuit board 15 is a, a linear expansion coefficient of the resin 30a is b, and a linear expansion coefficient of the inner case 20 is c, it is preferable that the three linear expansion coefficients satisfy a relationship of Formula (2).

a≈b>>c Formula (2)

For example, in the materials in the preferred examples described above, the circuit board 15 is a glass epoxy board and has a linear expansion coefficient a of 40 ppm/° C., the resin 30a is an epoxy adhesive and has a linear expansion coefficient b of 41 ppm/° C., and the inner case 20 is made of aluminum and has a linear expansion coefficient c of 23 ppm/° C., which indicates that the relationship of Formula (2) is established.

The hardness of the resin 30a and Formula (2) are derived based on the experimental results conducted by the inventors or the like, and contents of the experiments will be described in the following Examples.

### Examples

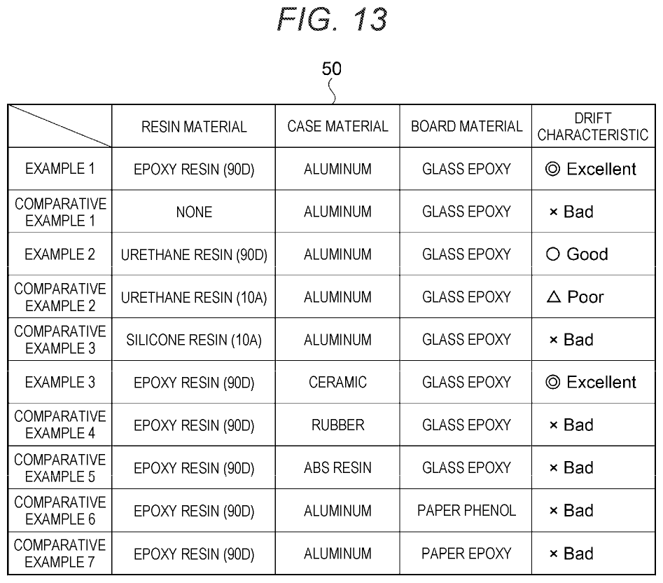

FIG. 13 is a list of Examples and Comparative Examples.

Table 50 of FIG. 13 is a table showing the experimental results conducted by the inventors or the like in order to derive the hardness of the resin 30a, Formula (2), and the like.

In the contents of the experiments, drift characteristics of the sensor output of the acceleration sensor when the material of the resin 30a, the material of the inner case 20, and the material of the circuit board 15 were changed were confirmed. In the experiment, the circuit board 15 on which only the acceleration sensor 18a was mounted was used.

First, Example 1 had the same settings as those of the preferred examples described above, the resin 30a was an epoxy adhesive, the inner case 20 was made of aluminum, and the circuit board 15 was a glass epoxy board. As the epoxy adhesive, a one-liquid thermosetting epoxy adhesive having a hardness of 90D after curing was used. FR4 was used as the glass epoxy board.

As a result, almost no drift occurred in the sensor output, and a very good characteristic “Excellent” was obtained.

In Comparative Example 1, the resin 30a was not provided, the other settings were the same as those of Examples, the inner case 20 was made of aluminum, and the circuit board 15 was a glass epoxy board.

As a result, the drift occurred in the sensor output, and the drift characteristic was NG “Bad”.

In Example 2, a urethane adhesive having a hardness of 90D after curing was used as the resin 30a. The other settings were the same as those of Example 1, the inner case 20 was made of aluminum, and the circuit board 15 was a glass epoxy board.

As a result, the drift that occurred in the sensor output was slight, and a good characteristic “Good” was obtained.

In Comparative Example 2, a urethane adhesive having a hardness of 10A after curing was used as the resin 30a. The other settings were the same as those of Example 1, the inner case 20 was made of aluminum, and the circuit board 15 was a glass epoxy board.

As a result, the drift was generated in the sensor output, and a drift characteristic in an allowable level was not obtained, which was “Poor”.

In Comparative Example 3, a silicone adhesive having a hardness of 10A after curing was used as the resin 30a. The other settings were the same as those of Example 1, the inner case 20 was made of aluminum, and the circuit board 15 was a glass epoxy board.

As a result, the drift occurred in the sensor output, and the drift characteristic was NG “Bad”.

In Example 3, the inner case 20 was made of ceramic. The other settings were the same as those of Example 1, the resin 30a was an epoxy adhesive, and the circuit board 15 was a glass epoxy board.

As a result, almost no drift occurred in the sensor output, and a very good characteristic “Excellent” was obtained. When the inner case 20 was made of glass, very good characteristics were similarly obtained.

In Comparative Example 4, the inner case 20 was made of rubber. The other settings were the same as those of Example 1, the resin 30a was an epoxy adhesive, and the circuit board 15 was a glass epoxy board.

As a result, the drift occurred in the sensor output, and the drift characteristic was NG “Bad”.

In Comparative Example 5, the inner case 20 was made of ABS resin. The other settings were the same as those of Example 1, the resin 30a was an epoxy adhesive, and the circuit board 15 was a glass epoxy board.

As a result, the drift occurred in the sensor output, and the drift characteristic was NG “Bad”. Similarly, when the material of the inner case 20 is polyethylene resin, the drift characteristic is NG, and it is assumed that the same applies to a case where other thermoplastic resins are used.

In Comparative Example 6, the circuit board 15 was made of a paper phenol board. FR1 was used as the paper phenol board. The other settings were the same as those of Example 1, the resin 30a was an epoxy adhesive, and the inner case 20 was made of aluminum.

As a result, the drift occurred in the sensor output, and the drift characteristic was NG “Bad”.

In Comparative Example 7, the circuit board 15 was made of a paper epoxy board. FR3 was used as the paper epoxy board. The other settings were the same as those of Example 1, the resin 30a was an epoxy adhesive, and the inner case 20 was made of aluminum.

As a result, the drift occurred in the sensor output, and the drift characteristic was NG “Bad”.

From these results, the following contents are considered.

From the results of Example 1, Example 2, Comparative Example 1, Comparative Example 2, and Comparative Example 3, it can be understood that the resin 30a is necessary to obtain the desired drift characteristics, and that even when the resin 30a is provided, the soft resin is inappropriate.

From the results of Example 1, Example 2, Example 3, Comparative Example 4, and Comparative Example 5, it can be seen that the soft material is inappropriate as the material of the inner case 20 in order to obtain the desired drift characteristics. From the results of Example 1 and Example 3, it can be understood that the material of the inner case 20 is preferably a material that is hard and has thermal deformation smaller than those of the resin 30a and the circuit board 15. Specifically, it can be seen that a material having a linear expansion coefficient smaller than those of the resin 30a and the circuit board 15 is appropriate. The linear expansion coefficient of aluminum is 23 ppm/° C., and the linear expansion coefficient of ceramic is 7 to 10 ppm/° C. Therefore, the linear expansion coefficient is sufficiently smaller than 40 ppm/° C. of the glass epoxy board and 41 ppm/° C. of the epoxy adhesive, and these materials are appropriate as the material of the inner case 20. Formula (2) is derived based on these results.

In Example 1, the experiment was performed with the hardness of the resin 30a set to 90D, but according to the experimental results by the inventors and the like, it was confirmed that the drift characteristics equivalent to those in the case of the hardness of 90D were obtained as long as the hardness was 80D or more.

In Example 1, the experiment was performed with the inner case 20 made of aluminum, but according to the experimental results by the inventors and the like, it was confirmed that the drift characteristics equivalent to those in the case of aluminum were obtained as long as the inner case 20 was made of metal. As the metal, for example, steel, titanium, copper, brass, aluminum, or an alloy thereof may be used.

As described above, according to the inertial measurement device 100 in the embodiment, the following effects can be obtained.

The inertial measurement device 100 includes the circuit board 15, the acceleration sensor 18a as the first inertial sensor, and the acceleration sensor 18b as the second inertial sensor paired with the acceleration sensor 18a. The acceleration sensor 18a and the acceleration sensor 18b are mounted on the circuit board 15 in the state where the directions of the detection axes of the acceleration sensor 18a and the acceleration sensor 18b are rotated by 180°. The inertial measurement device 100 further includes the inner case 20 as a case that accommodates the circuit board 15, and the spaces between the acceleration sensor 18a and the inner case 20 and between the acceleration sensor 18b and the inner case 20 are filled with the resin 30a.

Accordingly, the acceleration sensor 18a and the acceleration sensor 18b are mounted on the circuit board 15 in a state where the Xa direction as the direction of the first detection axis of the acceleration sensor 18a and the Xb direction as the direction of the second detection axis of the acceleration sensor 18b are rotated by 180° relative to each other. The same applies to the Ya direction and the Yb direction. In other words, since the acceleration sensor 18a and the acceleration sensor 18b are mounted on the circuit board 15 in a state where the directions of the detection axes of the acceleration sensor 18a and the acceleration sensor 18b are rotated by 180°, the output of the acceleration sensor 18b is reversed to a negative output and is averaged with the output of the acceleration sensor 18a, so that the temperature hysteresis characteristics can be offset.

Further, the acceleration sensors 18a and 18b are sealed with the resin 30a in a state where the acceleration sensors 18a and 18b are mounted on the circuit board 15. Therefore, even if the acceleration sensor is a resin package, moisture can be prevented from intruding the sensor, and moisture resistance characteristics are excellent. In addition, the space between the third concave portion 23 of the inner case 20 and the first surface 15a of the circuit board 15 is filled with the resin 30a, and three members are bonded to one another. Accordingly, since the circuit board 15 is integrated with the inner case 20 made of metal having little temperature deformation, it is possible to prevent the circuit board 15 from being warped, and it is possible to obtain the desired drift characteristic.

Therefore, it is possible to provide the inertial measurement device 100 having excellent temperature characteristics and moisture resistance characteristics and high detection accuracy.

The circuit board 15 has a first surface 15a and a second surface 15b opposite from the first surface 15a, and the acceleration sensor 18a and the acceleration sensor 18b are mounted on the first surface 15a.

Accordingly, the two acceleration sensors 18a and 18b capable of canceling the temperature hysteresis characteristic can be mounted on the first surface 15a of the circuit board 15.

The acceleration sensor 18a and the acceleration sensor 18b are the same acceleration sensor, and when the height of the acceleration sensor 18a is h, the distance d1 between the acceleration sensor 18a and the acceleration sensor 18b satisfies Formula (1).

Accordingly, the space between the acceleration sensor 18a and the acceleration sensor 18b is reliably filled with the resin 30a.

The first case is the inner case 20, and the second case is the outer case 1 that accommodates the inner case 20 in a state in which the circuit board 15 is set.

Accordingly, since the inner case 20 including the circuit board 15 can be accommodated in the outer case 1, the compact inertial measurement device 100 can be provided.

The hardness of the resin 30a is 80D or more in terms of the type D durometer in the durometer hardness test of JIS7215-1986.

Accordingly, since the circuit board 15 and the metal case are bonded and integrated by the resin 30a having high hardness, rigidity of the entire rigidity is increased, and it is possible to prevent the circuit board 15 from being warped.

### Second Embodiment

### Different Mounting Status-1

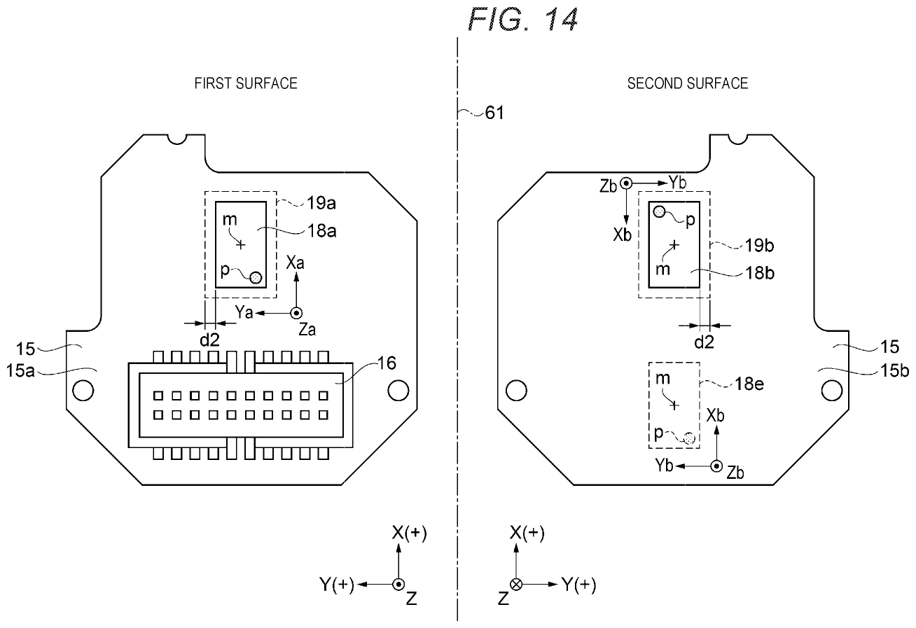

FIG. 14 is a plan view of a circuit board according to a second embodiment, and corresponds to FIG. 5.

In the above-described embodiment, the two acceleration sensors 18a and 18b are mounted on the first surface 15a of the circuit board 15 in a state where the directions of the detection axes thereof are rotated by 180°. The present disclosure is not limited to this configuration, any arrangement may be adopted as long as the detection axes are oriented in opposite directions, and one of the acceleration sensors may be mounted on the second surface 15b of the circuit board 15. For example, the acceleration sensor 18b of the embodiment is mounted on the second surface 15b of the circuit board 15. Hereinafter, the same reference numerals are given to the same portions as those of the above-described embodiment, and redundant description thereof will be omitted.

In FIG. 14, the first surface 15a and the second surface 15b of the circuit board 15 are shown left and right with an imaginary line 61 as an axis of symmetry. In other words, the mounting status on the front surface and the back surface of the circuit board 15 are illustrated side by side.

Only one acceleration sensor 18a as the first inertial sensor is mounted on the first surface 15a of the circuit board 15. An arrangement posture of the acceleration sensor 18a is the same as that of FIG. 5, and the directions of the three detection axes of the acceleration sensor 18a coincide with the IMU detection axis. No resist 19a is provided immediately below and around the acceleration sensor 18a.

Only one acceleration sensor 18b as the second inertial sensor is mounted on the second surface 15b of the circuit board 15. The acceleration sensor 18b is a sensor paired with the acceleration sensor 18a, and is mounted at an overlapping position on the back surface of the acceleration sensor 18a in a preferred example.

In the acceleration sensor 18b, since the reference point p is located at the vertex in the X(+) direction and the Y(−) direction, detection directions are the Xb direction, the Yb direction, and the Zb direction as indicated by the coordinate axis. The Xb direction is opposite from the X(+) direction of the IMU detection axis. The Yb direction is the same as the Y(+) direction of the IMU detection axis. The Zb direction is opposite from the Z(+) direction of the IMU detection axis. That is, detection directions of the acceleration sensor 18b on the X axis and the Z axis are reversed with respect to the detection directions of the acceleration sensor 18a.

According to the mounting status of the embodiment, the temperature hysteresis characteristics in the X axis and the Z axis can be cancelled by using the reversed sensor output of the acceleration sensor 18b based on the method for correcting the temperature hysteresis characteristics described above.

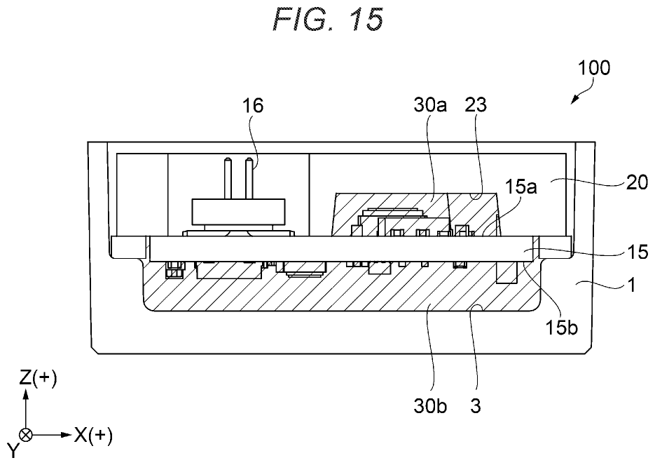

FIG. 15 is a cross-sectional view taken along a line f-f of FIG. 2, and corresponds to FIG. 11.

As shown in FIG. 15, in the present mounting status, in addition to the filling of the resin 30a on an inner case 20 side, an outer case 1 side is also filled with resin 30b. Specifically, a space between the first concave portion 3 of the outer case 1 and the second surface 15b of the circuit board 15 is filled with the resin 30b. The resin 30b is the same resin as the resin 30a. The resin 30b covers the electronic components including the acceleration sensor 18b mounted on the second surface 15b, and an inside of the first concave portion 3 is filled with the resin 30b. In other words, the spaces between the acceleration sensor 18a and the inner case 20 and between the acceleration sensor 18b and the outer case 1 are filled with the resin 30a and 30b.

An arrangement posture of the acceleration sensor 18b may be a posture of an acceleration sensor 18e indicated by a dotted line in FIG. 14. In the acceleration sensor 18e, since the reference point p is located at a vertex in the X(−) direction and the Y(+) direction, detection directions on the Y axis and the Z axis are reversed with respect to the detection direction of the acceleration sensor 18a. Accordingly, the temperature hysteresis characteristics in the Y axis and the Z axis can be cancelled.

As described above, according to the inertial measurement device 100 in the embodiment, the following effects can be obtained in addition to the effects of the above-described embodiments.

In the inertial measurement device 100, the circuit board 15 has the first surface 15a and the second surface 15b on the opposite side from the first surface 15a, the acceleration sensor 18a as the first inertial sensor is mounted on the first surface 15a, the acceleration sensor 18b as the second inertial sensor is mounted on the second surface 15b, the case is made of metal, the inner case 20 as the first case covering the first surface 15a side and the outer case 1 as the second case covering the second surface 15b side are included, and the spaces between the acceleration sensor 18a and the inner case 20 and between the acceleration sensor 18b and the outer case 1 are filled with the resin 30a and 30b.

Accordingly, since the acceleration sensor 18a and the acceleration sensor 18b are mounted on the front and back surfaces of the circuit board 15 in a state where the directions of the detection axes of the acceleration sensor 18a and the acceleration sensor 18b are rotated by 180°, the output of the acceleration sensor 18b is reversed to a negative output and is averaged with the output of the acceleration sensor 18a, so that the temperature hysteresis characteristics can be offset.

Further, the acceleration sensors 18a and 18b are sealed with the resin 30a, 30b in the state where the acceleration sensors 18a and 18b are mounted on the circuit board 15. Therefore, even if the acceleration sensor is a resin package, moisture can be prevented from intruding the sensor, and moisture resistance characteristics are excellent.

The circuit board 15 is bonded to the inner case 20 and the outer case 1 by the resin 30a and 30b. Accordingly, since the entire circuit board 15 is integrated with the metal case having little temperature deformation, it is possible to prevent the circuit board 15 from being warped, and it is possible to obtain the desired drift characteristic.

Therefore, it is possible to provide the inertial measurement device 100 having excellent temperature characteristics and moisture resistance characteristics and high detection accuracy.

### Third Embodiment

### Different Mounting Status-2

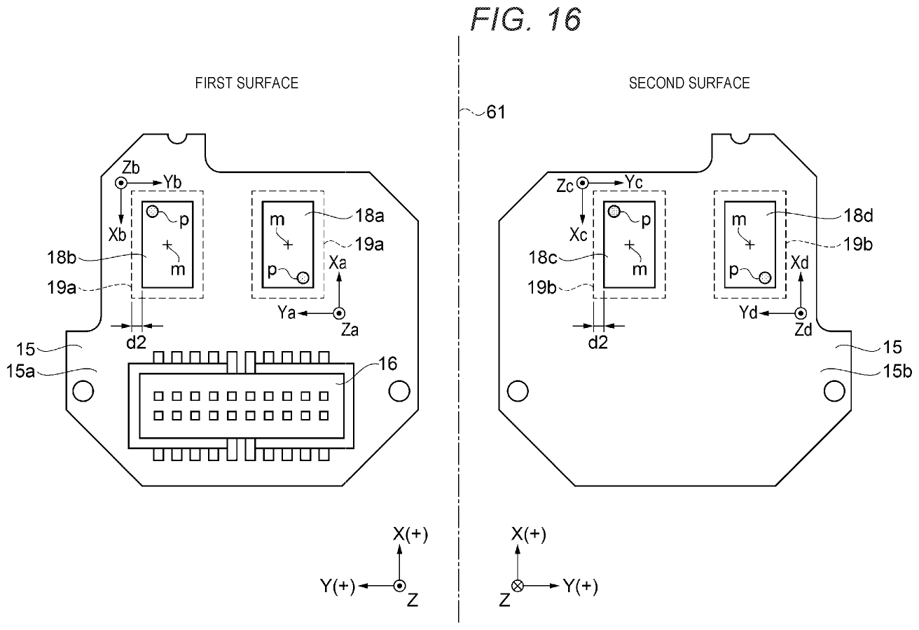

FIG. 16 is a plan view of a circuit board according to a third embodiment, and corresponds to FIGS. 5 and 14.

In the above-described embodiment, the pair of acceleration sensors 18a and 18b are mounted on the first surface 15a of the circuit board 15 in a state where the directions of the detection axes thereof are rotated by 180°, but the present disclosure is not limited to this configuration, and a plurality pairs of acceleration sensors may be provided, and a pair of acceleration sensors may be further mounted on the second surface 15b. For example, in the embodiment, a pair of acceleration sensors are mounted on each of the front and back surfaces of the circuit board 15. Hereinafter, the same reference numerals are given to the same portions as those of the above-described embodiment, and redundant description thereof will be omitted.

In FIG. 16, the first surface 15a and the second surface 15b of the circuit board 15 are shown left and right with an imaginary line 61 as an axis of symmetry.

An acceleration sensor pair including the acceleration sensor 18a and the acceleration sensor 18b is mounted on the first surface 15a of the circuit board 15. The arrangement postures of the acceleration sensors 18a and 18b are the same as that in FIG. 5, and the directions of the detection axes of the acceleration sensors 18a and 18b are reversed in the X axis and the Y axis.

An acceleration sensor 18c as a third inertial sensor and an acceleration sensor 18d as a fourth inertial sensor are mounted on the second surface 15b of the circuit board 15 so as to be spaced apart from each other. In a preferred example, the acceleration sensor 18c is mounted at an overlapping position on the back surface of the acceleration sensor 18a, and the acceleration sensor 18d is mounted at an overlapping position on the back surface of the acceleration sensor 18b.

In the acceleration sensor 18c, since the reference point p is located at the vertex in the X(+) direction and the Y(−) direction, detection directions are an Xc direction, a Yc direction, and a Zc direction as indicated by the coordinate axis. The Xc direction is opposite from the X(+) direction of the IMU detection axis. The Yc direction is the same as the Y(+) direction of the IMU detection axis. The Zc direction is opposite from the Z(+) direction of the IMU detection axis. The Xc direction, the Yc direction, and the Zc direction correspond to a third detection axis of the acceleration sensor 18c. An Xd direction, a Yd direction, and a Zd direction correspond to a fourth detection axis of the acceleration sensor 18d. In other words, the acceleration sensor 18c and the acceleration sensor 18d are mounted on the circuit board 15 in a state where the Xc direction as the direction of the third detection axis of the acceleration sensor 18c and the Xd direction as the direction of the fourth detection axis of the acceleration sensor 18d are rotated by 180°. The same applies to the Yc direction and the Yd direction. Note that the present disclosure is not limited to the X axis and the Y axis, and may be implemented in any mounting status as long as the sensor includes a detection axis in which the direction of the third detection axis of the acceleration sensor 18c and the direction of the fourth detection axis of the acceleration sensor 18d are opposite from each other.

The acceleration sensor 18d is mounted in a state of being rotated by 180° from the acceleration sensor 18c with the center point m as a rotation center on the second surface 15b. As a result, detection directions of the acceleration sensor 18d on the X axis and the Y axis are opposite from detection directions of the acceleration sensor 18c. In particular, since the detection directions of the acceleration sensors 18c and 18d on the Z axis are reversed with respect to the detection direction of the acceleration sensor 18a, the temperature hysteresis characteristic on the Z axis can be cancelled by the above-described method for correcting the temperature hysteresis characteristic.

Further, similarly to the description in FIG. 15, the spaces between the acceleration sensors 18a and 18b and the inner case 20 and between the acceleration sensors 18c and 18d and the outer case 1 are filled with the resin 30a and 30b.

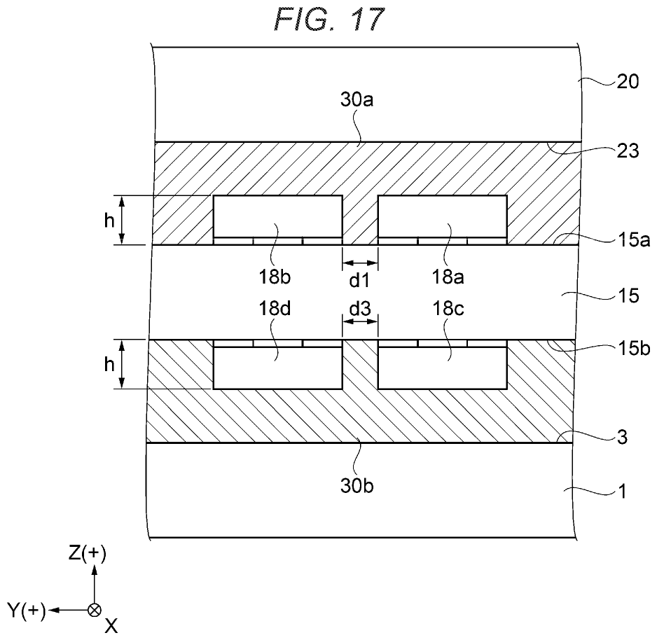

FIG. 17 is a cross-sectional view taken along a line j-j of FIG. 10, and corresponds to FIG. 12.

In FIG. 16, the acceleration sensor 18a and the acceleration sensor 18b are illustrated at a distance from each other as compared with FIG. 5, but the gap d1 between the acceleration sensor 18a and the acceleration sensor 18b may be any dimension as long as the gap satisfies the above-described Formula (1), and the same applies to the second surface 15b. Specifically, as shown in FIG. 17, when the acceleration sensors 18a and 18b on the first surface 15a are disposed with the gap d1, the acceleration sensors 18c and 18d on the second surface 15b are disposed on back surfaces of the acceleration sensors 18a and 18b. A gap d3 of the acceleration sensors 18c and 18d is obtained by Formula (3), where h is a package height of the acceleration sensor 18c.

d3≥h/1.66 Formula (3)

Thus, as shown in FIG. 17, the gap d3 between the acceleration sensor 18c and the acceleration sensor 18d is also filled with the resin 30b. In other words, if a distance equal to or larger than the gap d3 is secured between the acceleration sensor 18c and the acceleration sensor 18d, the gap can be reliably filled with the resin 30b.

As described above, according to the inertial measurement device 100 in the embodiment, the following effects can be obtained in addition to the effects of the above-described embodiments.

The inertial measurement device 100 further includes the acceleration sensor 18c as the third inertial sensor and the acceleration sensor 18d as the fourth inertial sensor paired with the acceleration sensor 18c. The acceleration sensor 18c and 18d are mounted on the second surface 15b of the circuit board 15 in a state where the Xc direction as the direction of the third detection axis of the acceleration sensor 18c and the Xd direction as the direction of the fourth detection axis of the acceleration sensor 18d are rotated by 180° relative to each other. The case is made of metal. The inertial measurement device 100 further includes the inner case 20 as the first case that covers the first surface 15a side, and the outer case 1 as the second case that covers the second surface 15b side, and spaces between the acceleration sensors 18a and 18b and the inner case 20 and between the acceleration sensors 18c and 18d and the outer case 1 are filled with the resin 30a and 30b.

Accordingly, since the acceleration sensor pair including the acceleration sensors 18c and 18d whose detection directions in the Z axis are reversed is provided on the second surface 15b, the temperature hysteresis characteristics in the Z axis in addition to the X axis and the Y axis can be cancelled out.

Further, the acceleration sensors 18a and 18b and the acceleration sensors 18c and 18d are sealed with the resin 30a, 30b in the state where the acceleration sensors 18a and 18b and the acceleration sensors 18c and 18d are mounted on the circuit board 15. Therefore, even if the acceleration sensor is a resin package, moisture can be prevented from intruding the sensor, and moisture resistance characteristics are excellent.

The acceleration sensor 18c and the acceleration sensor 18d are the same inertial sensor, and when the height of the acceleration sensor 18c is h, the distance d3 between the acceleration sensor 18c and the acceleration sensor 18d satisfies Formula (3).

Accordingly, the space between the acceleration sensor 18c and the acceleration sensor 18d is reliably filled with the resin 30b.

The circuit board 15 is bonded to the inner case 20 and the outer case 1 by the resin 30a and 30b. Accordingly, since the entire circuit board 15 is integrated with the metal case having little temperature deformation, it is possible to prevent the circuit board 15 from being warped, and it is possible to obtain the desired drift characteristic.

Therefore, it is possible to provide the inertial measurement device 100 having excellent temperature characteristics and moisture resistance characteristics and high detection accuracy.

### Fourth Embodiment

### Different Mounting Status-3

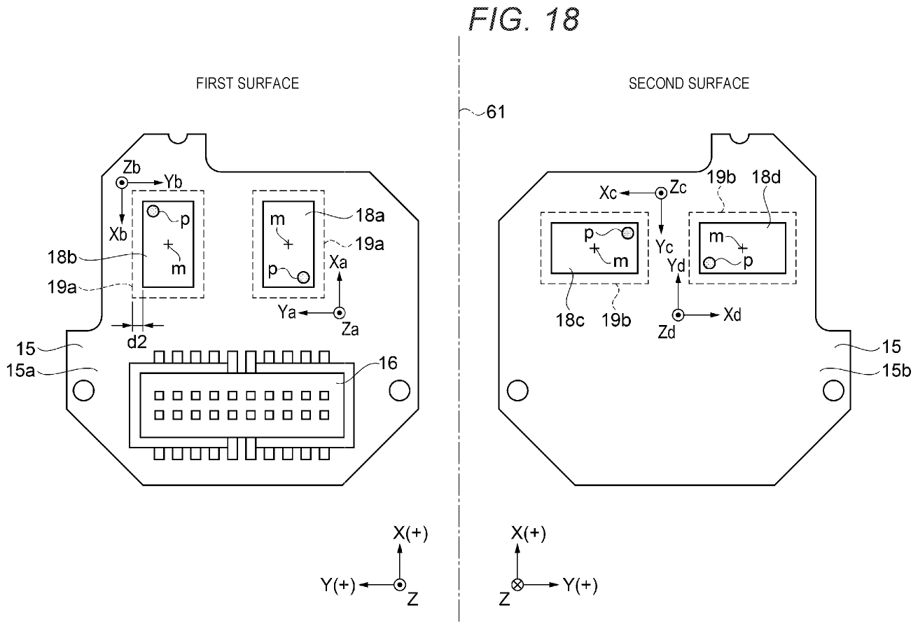

FIG. 18 is a plan view of a circuit board according to a fourth embodiment, and corresponds to FIG. 16.

In the configuration of the third embodiment, the arrangement postures of the acceleration sensor 18c and the acceleration sensor 18d on the second surface 15b may be further changed. For example, in the embodiment, the direction of the acceleration sensor 18c is rotated by 90° as compared with FIG. 16. The same applies to the acceleration sensor 18d. Hereinafter, the same reference numerals are given to the same portions as those of the above-described embodiment, and redundant description thereof will be omitted.

In FIG. 18, the first surface 15a and the second surface 15b of the circuit board 15 are shown left and right with an imaginary line 61 as an axis of symmetry.

The mounting status in which the acceleration sensors 18a and 18b are mounted on the first surface 15a of the circuit board 15 is the same as the mounting status in which the acceleration sensors 18a and 18b are mounted on the first surface 15a of FIG. 16.

Although the acceleration sensors 18c and 18d are mounted as a pair on the second surface 15b of the circuit board 15, the directions of the acceleration sensors 18c and 18d are rotated by 90° as compared with FIG. 16. Specifically, the acceleration sensor 18c is mounted in a state of being rotated by 90° from the acceleration sensor 18c of FIG. 16 with the center point m as a rotation center on the second surface 15b. As a result, a long-side direction of the acceleration sensor 18c is along the Y(+) direction of the IMU detection axis. The Xc direction in the detection direction of the acceleration sensor 18c is a direction opposite from the Y(+) direction of the IMU detection axis. The Yc direction is a direction opposite from the X(+) direction of the IMU detection axis. The Zc direction is a direction opposite from the Z (+) direction of the IMU detection axis.

The acceleration sensor 18d is mounted in a state of being rotated by 90° from the acceleration sensor 18d of FIG. 16 with the center point m as a rotation center on the second surface 15b. As a result, the Xd direction in the detection direction of the acceleration sensor 18d is opposite from the Xc direction of the acceleration sensor 18c. The Yd direction is opposite from the Yc direction of the acceleration sensor 18c. The Zd direction is the same as the Zc direction of the acceleration sensor 18c.

Further, similarly to the description in FIG. 15, the spaces between the acceleration sensors 18a and 18b and the inner case 20 and between the acceleration sensors 18c and 18d and the outer case 1 are filled with the resin 30a and 30b.

In FIGS. 16 and 18, two acceleration sensors forming a pair are provided on the first surface 15a of the circuit board 15, and two acceleration sensors forming a pair are also provided on the second surface 15b, but the present disclosure is not limited to this configuration, for example, the number of inertial sensors may be multiples of two, and four acceleration sensors may be provided on the first surface 15a.

As described above, according to the inertial measurement device 100 in the embodiment, the following effects can be obtained in addition to the effects of the above-described embodiments.

Accordingly, since the acceleration sensor pair including the acceleration sensors 18c and 18d whose detection directions in the Z axis are reversed is provided on the second surface 15b, the temperature hysteresis characteristics in the Z axis in addition to the X axis and the Y axis can be cancelled out.

Further, since the Xc direction and the Xd direction of the acceleration sensors 18c and 18d correspond to the Y axis of the IMU detection axis, and the Yc direction and the Yd direction correspond to the X axis of the IMU detection axis, it is possible to reduce a difference between the X axis and the Y axis.

Therefore, it is possible to provide the inertial measurement device 100 having excellent temperature characteristics and moisture resistance characteristics and high detection accuracy.

### Fifth Embodiment

### Different Mounting Status-4

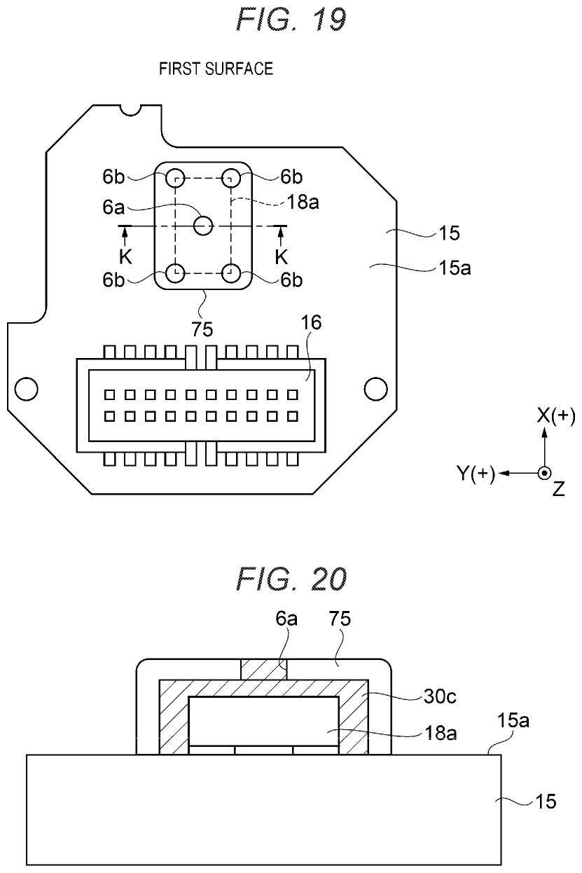

FIG. 19 is a plan view of a circuit board according to a fifth embodiment, and corresponds to FIG. 14. FIG. 20 is a cross-sectional view taken along a line k-k in FIG. 19.

In the embodiments described above, the spaces between the circuit board 15 and the case are filled with the resin 30a and 30b, but the configuration is not limited thereto, and a cover covering the acceleration sensor may be provided and the cover may be filled with the resin. For example, in the embodiment, a cover member 75 that covers the acceleration sensor 18a is provided. Hereinafter, the same reference numerals are given to the same portions as those of the above-described embodiment, and redundant description thereof will be omitted.

As shown in FIG. 19, the acceleration sensor 18a is covered with the cover member 75 as a first cover. The cover member 75 has a rectangular shape slightly larger than the acceleration sensor 18a in plan view, and is a tray-shaped lid member having a storage space. In a preferred example, aluminum is used as the material, but any metal may be used as long as the metal is applicable to the inner case 20 described above.

The cover member 75 is provided with a plurality of holes. Specifically, a hole 6a is provided in the center of the cover member 75, and holes 6b are provided in the vicinity of four vertices, respectively.

As shown in FIG. 20, the cover member 75 is filled with resin 30c. The resin 30c is the same resin as the resin 30a. Specifically, a space between the acceleration sensor 18a mounted on the first surface 15a of the circuit board 15 and an inner surface of the cover member 75 is filled with the resin 30c. In a preferred example, the resin 30c is injected from the hole 6a at the center of the cover member 75. The four surrounding holes 6b are holes for discharging a gas generated when the injected resin is cured. One or more holes 6b may be provided.

Although not shown in FIG. 19, the acceleration sensor 18b on the second surface 15b of the circuit board 15 is similarly covered with the cover member 75 as a second cover, and the cover member 25 is filled with the resin 30c. The cover member 75 can also be applied to other mounting status including FIGS. 4, 16, and 18.

As described above, according to the inertial measurement device 100 in the embodiment, the following effects can be obtained in addition to the effects of the above-described embodiments.

The inertial measurement device 100 includes the circuit board 15, the acceleration sensor 18a as the first inertial sensor, and the acceleration sensor 18b as the second inertial sensor paired with the acceleration sensor 18a. The acceleration sensor 18a and the acceleration sensor 18b are mounted on the circuit board 15 in the state where the directions of the detection axes of the acceleration sensor 18a and the acceleration sensor 18b are rotated by 180°. The inertial measurement device 100 further includes the cover member 75 as the first cover that covers the acceleration sensor 18a and the cover member 75 as the second cover that covers the acceleration sensor 18b, and the spaces between the acceleration sensor 18a and the cover member 75 and between the acceleration sensor 18b and the cover member 75 are filled with the resin 30c.

Even in the case where the cover member 75 is used, the effects of improving the temperature hysteresis characteristic, the moisture resistance characteristic, and the drift characteristic can be obtained as in the above-described mounting status.

Therefore, it is possible to provide the inertial measurement device 100 having excellent temperature characteristics and moisture resistance characteristics and high detection accuracy.

In addition, the cover member 75 is a metal lid member, and the cover member 75 is provided with the hole 6a as the injection hole for filling with the resin 30c and the hole 6b as a discharge hole for discharging a gas generated when the resin is cured.

Accordingly, after the resin is injected from the hole 6a, the gas can be vented from the hole 6b at the time of curing, so that work efficiency is good and the inside of the cover member 75 can be filled with the resin 30c without a gap.

What is claimed is:

1. An inertial measurement device comprising:
a first inertial sensor having at least a first detection axis;
a second inertial sensor having at least a second detection axis and paired with the first inertial sensor;
a circuit board on which the first inertial sensor and the second inertial sensor are mounted in a state where a direction of the first detection axis of the first inertial sensor is rotated by 180° with respect to a direction of the second detection axis of the second inertial sensor;
a case accommodating the circuit board; and
resin with which spaces between the first inertial sensor and the case and between the second inertial sensor and the case are filled.

2. The inertial measurement device according to claim 1, wherein
the circuit board has a first surface, and a second surface opposite from the first surface,
the first inertial sensor is mounted on the first surface,
the second inertial sensor is mounted on the second surface,
the case is made of metal and includes a first case that covers a first surface side and a second case that covers a second surface side, and
spaces between the first inertial sensor and the first case and between the second inertial sensor and the second case are filled with the resin.

3. The inertial measurement device according to claim 1, wherein
the circuit board has a first surface, and a second surface opposite from the first surface,
the first inertial sensor and the second inertial sensor are mounted on the first surface,
the case is made of metal and includes a first case that covers a first surface side and a second case that covers a second surface side, and
spaces between the first inertial sensor and the first case and between the second inertial sensor and the first case are filled with the resin.

4. The inertial measurement device according to claim 3, wherein
the first inertial sensor and the second inertial sensor are the same inertial sensor, and
d1≥h/1.66
in which h is a height of the first inertial sensor, and
d1 is a distance between the first inertial sensor and the second inertial sensor.

5. The inertial measurement device according to claim 3, further comprising:
a third inertial sensor having at least a third detection axis; and
a fourth inertial sensor having at least a fourth detection axis and paired with the third inertial sensor, wherein
the third inertial sensor and the fourth inertial sensor are mounted on the second surface of the circuit board in a state where a direction of the third detection axis of the third inertial sensor and a direction of the fourth detection axis of the fourth inertial sensor are rotated by 180°,
the case is made of metal and includes a first case that covers the first surface side and a second case that covers the second surface side, and
spaces between the first inertial sensor and the first case and between the second inertial sensor and the first case, and between the third inertial sensor and the second case and between the fourth inertial sensor and the second case are filled with the resin.

6. The inertial measurement device according to claim 5, wherein
the third inertial sensor and the fourth inertial sensor are the same inertial sensor, and
d3≥h/1.66
in which h is a height of the third inertial sensor, and
d3 is a distance between the third inertial sensor and the fourth inertial sensor.

7. The inertial measurement device according to claim 2, wherein
the first case is an inner case, and
the second case is an outer case accommodating the first case in a state where the circuit board is set.

8. An inertial measurement device comprising:
a circuit board;
a first inertial sensor;
a second inertial sensor paired with the first inertial sensor; and
a first cover covering the first inertial sensor and a second cover covering the second inertial sensor, wherein
the first inertial sensor and the second inertial sensor are mounted on the circuit board in a state where directions of detection axes of the first inertial sensor and the second inertial sensor are rotated by 180°, and
spaces between the first inertial sensor and the first cover and between the second inertial sensor and the second cover are filled with resin.

9. The inertial measurement device according to claim 8, wherein
the first cover and the second cover are the same lid member made of metal, and
the first cover and the second cover are provided with an injection hole for filling with the resin and a discharge hole for discharging a gas generated when the resin is cured.

10. The inertial measurement device according to claim 1, wherein
a hardness of the resin is 80D or more in terms of a type D durometer in a durometer hardness test of JIS7215-1986.
